(19) United States
(12) Patent Application Publication
(10) Pub. No.: US 2022/0030754 A1
(43) Pub. Date: Feb. 3, 2022

(54) Oscillating Weeder

(71) Applicant: Stephan Jozlin, Battle Creek, MI (US)

(72) Inventor: Stephan Jozlin, Battle Creek, MI (US)

(21) Appl. No.: 16/947,409

(22) Filed: Jul. 31, 2020

(51) Int. Cl. A01B 1/06; A01B 1/22; A01B 1/16

(52) U.S. Cl. CPC A01B 1/065; A01B 1/16; A01B 1/227

(57) ABSTRACT

An agricultural tool including a powered motor that supplies vibration to a tool implement. The vibration allows a user to dig with decreased effort, and also reduces the likelihood of severing a root on a plant by replacing the linear force required to dig with transverse vibration. The tool includes a one-handed grip, allowing the user a free hand to assist with gardening activities.

### BACKGROUND

### Field of Technology

The present disclosure relates to agricultural tools that assist with gardening activities, more particularly gardening tools that can be used to remove weeds and plants from the ground.

### Description of Related Art

Garden and agricultural tools require a user to use a significant amount of force to dig through soil. This may be necessary to cultivate, transplant plants, or remove unwanted weeds. When force is used to dig, there is a risk of severing the roots of the plants and weeds. This can damage the quality of a desired plant and, for weeds, does not allow the roots to be completely removed, allowing for the weeds to re-establish from the unremoved roots.

To prevent severing of the roots, a garden tool may be used more deliberately and with less force, but this method is much slower and does not completely eliminate the possibility of severing roots.

Prior patents have attempted to solve this problem.

Japanese Patent Application Publication No. 2004/208675 discloses a long-handled shovel that uses a powered motor to linearly oscillate the shovel end to decrease the effort needed to dig. In this case, linear means in the direction of the long axis of the shovel body. The shovel uses the powered motor to increase the linear digging force. This force tends to sever plant roots, instead of removing them without disturbing the roots.

United States Patent Application No. 2011/0083865 discloses a tool with a long body with a powered motor that applies lateral motion to the tool implement. The motor assists users with physically demanding tasks, but must be held with two hands.

### SUMMARY

The present disclosure provides an agricultural tool, including a power supply and a motor wherein the motor supplies forced vibration to a tool implement. The power supply may include at least one of a cord and a battery. The tool implement may be at least one of a shovel, a spade, a hoe, a rake, a fork, a cultivator, a mattock, a pick, a post hole digger, an edger, a trowel, and a weeder. The vibration may be at least one of a linear vibration and rotational vibration, and preferably a combination of the two. The agricultural tool also includes a one-handed grip that allows for a user to assist gardening with a free hand. The grip may include a silicone cover to absorb vibration forces and to allow for easier handling.

The present disclosure also provides an agricultural tool including a tool end, wherein a tool implement may be lockably connected to the tool end. The tool implement may be interchangeable, allowing for different tool implements to be used on the agricultural tool.

### BRIEF DESCRIPTION OF THE DRAWINGS

FIG. 1 shows the body of an oscillating weeder.

FIG. 2 shows one embodiment of an oscillating weeder with a tool implement installed.

FIG. 3 shows one embodiment of a tool implement used with an oscillating weeder.

FIG. 3A shows vibration of a tool implement.

FIG. 3B shows an alternative tool implement used with an oscillating weeder.

FIG. 4 shows an exploded view of one embodiment of an oscillating weeder with a tool implement.

FIG. 5 shows one embodiment of an oscillating weeder in use.

### DETAILED DESCRIPTION

The following detailed description is of the best currently contemplated modes of practicing the present disclosure. The description is not to be taken in a limiting sense, but is made merely for the purpose of illustrating the general principles of the present disclosure since the scope of the present disclosure is best defined by the appended claims.

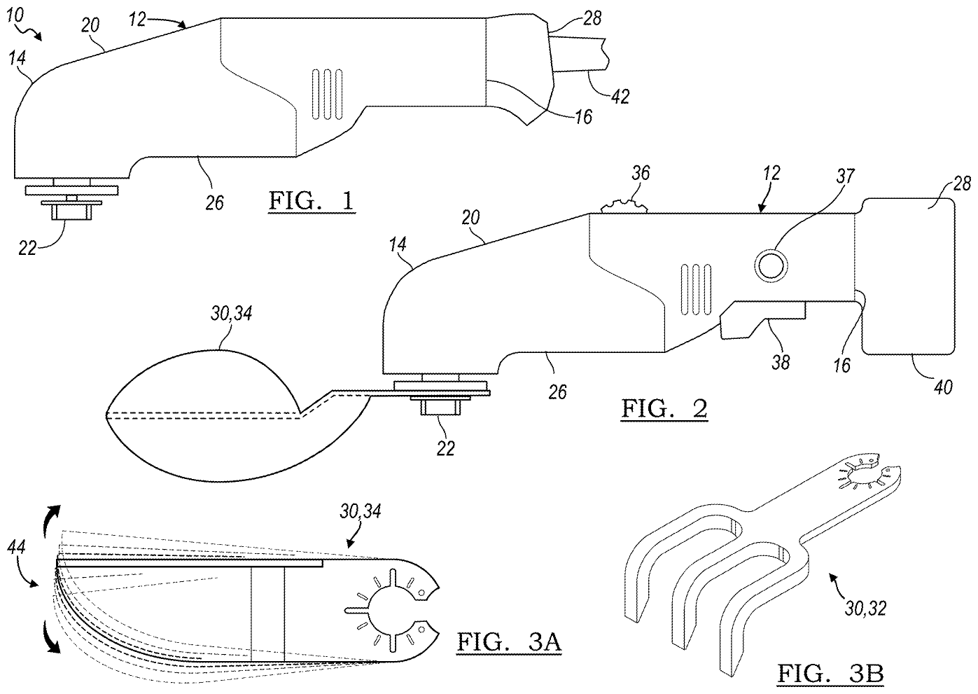

FIG. 1 provides an agricultural tool 10 with a body 12, a motor 46 for producing vibration, a power supply 28 for supplying power to the motor 46, and a tool implement 30.

One embodiment provides a tool implement 30 that includes a pronged instrument 32, which may be at least one of a fork, a weeder, or a rake. Another embodiment provides a tool implement 30 that includes a flat instrument 34, which may be at least one of a paddle, a spade, a shovel, a trowel, or a hoe.

In one embodiment, the agricultural tool 10 may have interchangeable tool implements 30 that engage a tool end 22 of the body 12. One embodiment provides the tool end 22 located near a first end 14 of the body 12. The interchangeable tool implements 30 may be removably engaged to the tool end 22. The tool implements 30 may be engaged through any suitable means, such as a physical connection including a spindle, a magnetic connection, or a lock and pin. One embodiment provides a tool implement 30 that is connected to the tool end 22 by at least one bolt. Another embodiment includes the tool implements 30 connecting to the tool by twisting into the tool end 22.

One embodiment provides the power supply 28 located near a second end 16 of the body. Another embodiment provides the motor 46 located between the first 14 and second ends 16.

FIG. 2 provides the agricultural tool 10 of FIG. 1, further including a flat instrument 34, a switch 38, and a throttle 36. The shown embodiment includes a physical connection of bolts to attach the tool implement 30 to the tool end 22.

The body 12 may be of a length to allow a user to hold the tool with one hand. One embodiment includes the handle of a length between 8 and 24 inches. Another embodiment includes the handle of a length between 8 and 12 inches. The body 12 may be made out of any suitable rigid material, including metals, polymers, and plastics. The body 12 may be hollow to act as a housing for components, such as the motor 46, the power supply 28, and physical and electronic connections to supply power and force to other parts of the tool. The body 12 may be covered in a grip 26 to provide additional benefits, such as vibration damping or slip resistance.

One embodiment provides the grip 26 consisting of an elastomeric cover 20.

The body 12 may consist of any suitable material, including metals, polymers, or plastics. One embodiment provides a contoured body 12 such that the body 12 has a smaller diameter to allow users of varying hand size to use the tool. The contour may be placed near the center of gravity of the tool to provide the user with a balanced tool.

FIGS. 2 and 3A provide a paddle as the tool implement 30, with FIG. 3A showing the vibration of the paddle. Another embodiment provides vibration rotating parallel to a plane defined by the paddle. The vibration may be general, in which the tool implement 30 moves in an undefined direction. FIG. 3B provides an example of an interchangeable pronged instrument 32. The vibration may act similarly to FIG. 3A, vibrating about a central axis 24 defined by the tool end 22.

The tool implements 30 may be made out of any suitable material, including metals, polymers, and plastics. One embodiment includes a curved body 12 near the tool end 22 to allow a view of the object to be removed.

The motor 46 may supply vibration to the tool implements 30 through any suitable means. One embodiment provides eccentric motion having an imbalance on an end of the motor 46. The vibration may be general, wherein an imbalance on the motor 46 produces uniform vibration throughout the tool. One embodiment provides the vibration acting laterally or transverse to an axis defined by the length of the body 12. Another embodiment provides the vibration acting laterally or transverse to an axis 24 defined by the tool end 22. The transverse vibration 44 may vibrate the tool perpendicular to the axis 24, providing vibrational movement to the tool implement 30. The perpendicular transverse vibration 44 may vibrate perpendicular to a plane defined by the tool implement 30. The transverse vibration 44 may also be rotational, wherein the transverse vibration 44 rotates about a defined axis 24.

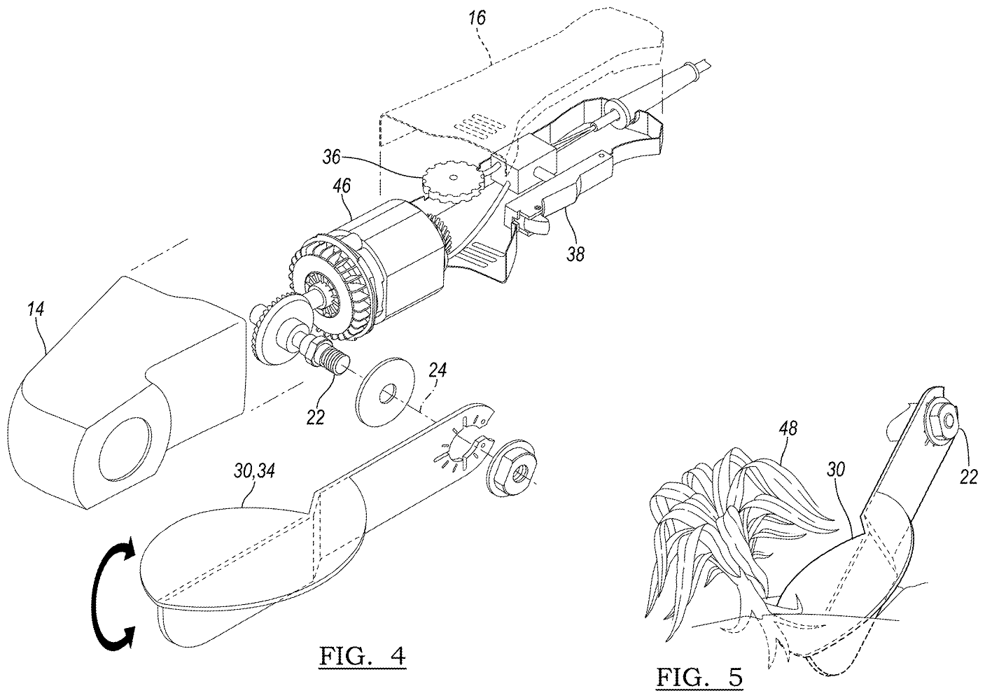

FIG. 4 provides a view of the agricultural tool 10 with a transparent body 12, showing the internal components of the tool. The components may include a motor 46, a power supply 28, a shaft attaching the motor 46 to a tool end 22 or a tool implement 30, a throttle 36, and a switch 38. The body 12 may have recesses to allow external control of the components. For example, a switch 38 may be externally placed on the body 12 to allow a user to turn the tool on or off. Additionally, a throttle 36 may be externally placed on the body 12 to allow the user to adjust the amount of vibration output.

One embodiment provides the throttle 36 and switch 38 components located between the first 14 and second ends 16. The throttle 36 may consist of a rotational input, allowing a user to adjust the amount of vibration over varying degrees. One embodiment provides the throttle 36 consisting of at least one button 37 and a controller, wherein preset vibration amounts are designated by the controller and controlled by the button(s) 37. The switch 38 may consist of a button 37 that activates and deactivates the motor 46. The switch 38 may also consist of a traditional switch 38 with a first position that deactivates the motor 46 and a second position that activates the motor 46.

One embodiment provides a cord 42 as the power supply 28, allowing the tool to be plugged into an outlet to power the motor 46. Another embodiment provides a battery 40 as the power supply 28.

FIG. 5 provides the use of the tool with the tool implement 30 contacting the roots of a plant 48 and using vibration to remove the plant 48 easily and without severing the roots. One embodiment provides for transverse vibration 44, with the tool vibrating through soil, wherein the tool contacts an object, such as a rock or plant 48 root, and directly applies vibration from the tool implement 30 to the object. The vibration transferred to an object, either from general vibration or transverse, loosens the soil around the object allowing for a user to remove the object with less force.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1. An agricultural tool, comprising:
a body having a first and second end, and a central axis intersecting a tool end;
a tool implement attached to the first end of the body;
a motor supplying a vibration to the tool implement; and
a power supply which provides power to the motor;
wherein the tool implement includes a panel having a flat plant moving surface and the motor vibrates the tool implement in a direction perpendicular to the flat plant moving surface, the tool implement further including a support brace comprising a support plate substantially perpendicular to the flat plant moving surface and connected to the panel at a surface opposite the flat plant moving surface.

2. The agricultural tool of claim 1, wherein the body further compromises an elastomeric cover.

3-4. (canceled)

5. The agricultural tool of claim 1, further comprising:
a throttle connected to the motor to selectively control the vibration.

6. The agricultural tool of claim 1, further comprising:
a switch to selectively disconnect the power supply to the motor.

7. The agricultural tool of claim 1, wherein the power supply comprises a battery.

8. The agricultural tool of claim 1, wherein the power supply comprises a cord adapted to plug into a power outlet.

9-16. (canceled)

17. A method for removing a plant from soil surrounding the plant, the method comprising:
providing an agricultural tool comprising a body having a first and second end, a tool implement engaged to the first end of the body, a motor for vibrating the tool implement, and a power supply which provides power to the motor;
providing the tool implement with a panel having a flat plant moving surface and a support brace comprising a support plate substantially perpendicular to the flat plant moving surface and connected to the panel at a surface opposite the flat plant moving surface;
vibrating the tool implement and inserting the tool implement into the soil such that the flat plant moving surface is moving toward the plant to thereby transfer a planar vibratory force to at least the soil surrounding the plant to thereby loosen the plant from the soil; and
pulling the plant out of the soil surrounding the plant.

18. (canceled)

19. The method of claim 17 further including contacting the plant with the tool implement.

20. (canceled)

21. A method for removing a plant from soil surrounding the plant, the method comprising:
providing an agricultural tool comprising a body having a first and second end, a tool implement engaged to the first end of the body, a motor for vibrating the tool implement, and a power supply which provides power to the motor;
providing the tool implement with a panel having a flat plant moving surface and a support brace comprising a support plate substantially perpendicular to the flat plant moving surface and connected to the panel at a surface opposite the flat plant moving surface;
inserting the tool implement into the soil;
vibrating the tool implement against the roots of the plant to thereby transfer an appositional vibratory force to the roots of the plant to thereby loosen the plant from the soil; and
pulling the plant out of the soil surrounding the plant.

22. (canceled)

23. The method of claim 21 further including contacting the plant with the tool implement.

24-25. (canceled)
